(19) United States
(12) Patent Application Publication
(10) Pub. No.: US 2016/0116223 A1
(43) Pub. Date: Apr. 28, 2016

(54) FERROHYDRODYNAMIC THERMAL MANAGEMENT SYSTEM AND METHOD

(71) Applicant: Fourier Electric, Inc., Winter Park, FL (US)

(72) Inventors: Brandon Carpenter, Winter Park, FL (US); Jonathan Wachob, Winter Park, FL (US); Keith Crisman, Ozark, MO (US); Matt Hopper, Winter Springs, FL (US); Dustin Pessatore, Lake Mary, FL (US); Ben McDeed, Orlando, FL (US)

(21) Appl. No.: 14/525,204

(22) Filed: Oct. 27, 2014

(51) Int. Cl. F28D 15/00; H02K 44/06; F25D 17/02

(52) U.S. Cl. CPC F28D 15/00; F25D 17/02; H02K 44/06

(57) ABSTRACT

A ferrohydrodynamic thermal management system is described and claimed. At least one ferrohydrodynamic pump is utilized to motivate a ferrofluid along a fluid communication channel. A primary heat exchanger transfers thermal energy from a system to be thermally managed to the ferrofluid, and a secondary heat exchanger transfers thermal energy from the ferrofluid to an external heat sink. The ferrofluid is motivated within the fluid communication channel by at least one time-varying magnetic field produced by at least one electromagnet, which may be driven by a time-varying electromagnet drive signal such that the motivation of the ferrofluid within the fluid communication channel is controlled in a desired fashion. The amount of thermal energy, or heat, removed from the system to be thermally managed is controllable and may be controlled by a controller that produces a desired time-varying electrical drive signal.

This is document is a non-provisional application for patent filed in the United States Patent and Trademark Office (USPTO) under 35 U.S.C. §111(a).

### CROSS REFERENCE TO RELATED APPLICATIONS

Not applicable.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The field of the invention relates generally to thermal management systems for equipment or systems that generate or require thermal energy and must be thermally managed in order to operate or function properly. More specifically, the invention relates to the use of ferrofluids motivated by magnetic fields in which the ferrofluids are contained within a fluid communication channel such as, for example, pipes, and in which the magnetic field is time-varying. The ferrofluid is motivated within the fluid communication channel by a time-varying magnetic field or fields, which may be characterized as having a magnitude that is a plurality of polyphase sinusoidally time-varying magnetic fields in a quadrature phase relationship. The ferrofluid thus motivated is used to transfer thermal energy between heat sources and heat sinks. As an example, the thermal management system of the invention may be utilized to transfer thermal energy from equipment or systems that generate thermal energy and which must be cooled in order to operate properly to a remoted heat sink by circulating the ferrofluid within the fluid communication channel through a heat exchanger or plurality of heat exchangers.

2. Background Art

The thermal management systems of the prior art typically rely upon mechanical pumps that comprise various mechanical configurations adapted to motivate a fluid. For example, positive displacement pumps typically motivate a fluid by trapping a fixed amount of fluid enforcing or displacing the trapped fluid into a discharge pipe. Some positive displacement pumps use an expanding cavity on a suction side of the pump and a decreasing cavity on a discharge side of the pump. Fluid or liquid flows into the pump as the cavity on the suction side expands, and the liquid flows out of the discharge side as the cavity on the discharge side collapses. One disadvantage of this type of positive displacement pumps is that they must not operate against a closed valve on the discharge side of the pump, because it has no shutoff head as, for instance, a centrifugal pump. A positive displacement pump of this type operating against a close discharge valve continues to produce flow causing the pressure in the discharge line, or pipe, to increase until the line bursts, the pump is severely damaged, or both.

Furthermore, positive displacement pumps rely upon translating or rotating components that are subject to wear-out over time, thus resulting in limited lifetime depending upon the environment and components from which the positive displacement pump is fabricated. Maintenance costs, including lost production due to down-time, can be significant for such pumps. In some application such as space-borne vehicles, it may not be possible to replace or repair a fluid pump that has failed, leading to degradation or loss of the mission and may pose a safety concern to on-board inhabitants.

Positive discharge pumps may be characterized as rotary type, reciprocating type, or linear type. However, all types of positive discharge pumps suffer from the drawbacks mentioned herein. In those situations in which very high reliability is required, such as, for example space applications, medical equipment applications and the like, positive displacement pumps may need to be operated in parallel or in some other failsafe scheme including redundant pumps, increasing size, cost, and weight of the pump system. Furthermore, positive displacement pumps require that some type mechanical moving parts be physically immersed in the liquid or fluid that is being pumped. This means that some structure must exist for passing the fluid from an external fluid communication channel through a volume whereupon it may be physically acted upon by the moving mechanism of the pump, and then passing the discharged fluid back into the fluid communication channel. This invariably means a system of seals, pipes, flanges, gaskets, sealants or other mechanical structures must be in place in order to prevent leakage of the fluid or liquid from the pump, the fluid communication channel, or the connections between them. Thus the positive displacement pumps of the prior art exhibit low reliability, high cost, high volume, and a significant likelihood of leakage. The positive displacement pumps of the prior art also generally require disassembly and invasion into the fluid communication channel in order to repair the pump. This typically means there will be a resulting discharge of the fluid contained within the fluid communication channel, which may be, for example a coolant, which may have negative environmental effects as such fluid may be toxic or classified as a pollutant.

The significance of the failure rate of positive displacement pumps is of such importance that meantime between failure (MTBF) for such pumps is closely tracked and monitored on a statistical basis and handbooks have been published on the subject. Unscheduled maintenance is often one of the most significant costs of operating positive displacement pumps.

What is needed in the art is a system and method for pumping fluids that it is highly reliable, comprises no moving parts and is not invasive in that it does not require any components to be physically placed within liquid or fluid that is being pumped. The system and method of the ferrohydrodynamic thermal management system of the present invention overcomes the aforementioned and other drawbacks of the prior art and represents a significant advancement in the state-of-the-art.

### BRIEF SUMMARY OF THE INVENTION

The present invention comprises an apparatus, system and method that may have one or more of the following features and/or steps, which alone, or in any combination, may comprise patentable subject matter.

The present invention overcomes the shortcomings of the prior art in that it provides a reliable and economic thermal management system in which a ferrofluid is contained within and motivated along a fluid communication channel by the application of time-varying magnetic fields in magnetic communication with the ferrofluid. The invention overcomes the drawbacks of prior systems by eliminating the need for invasive mechanical components or moving parts such as impellers, pump gears, or the like. The fluid communication channel comprise a fluid communication channel further comprising pipes, tubing, or similar structures which contain a ferrofluid that is in magnetic communication with, and motivated by, a time-varying magnetic field produced by at least one electromagnet that is in electrical communication with an electric drive circuit capable of supplying at least one time-varying electric current to said at least one electromagnet. As the ferrofluid is motivated around the fluid communication channel, it may remove heat or thermal energy from a heat source or primary heat exchanger that is in thermal communication with the fluid communication channel, and the fluid communication channel may transfer heat or thermal energy to a heat sink or secondary heat exchanger that is in thermal communication with the fluid communication channel.

The use of a time-varying magnetic field to motivate the ferrofluid within the fluid communication channel such that heat is removed from a system to be cooled by exchange of thermal energy eliminates the need for a traditional fluid pump, which may rely upon rotating impellers or other moving parts. Such traditional impellers are susceptible to failure in a number of modes such as blade failure, bearing failure and the like. Replacing such traditional impeller-type pumps typically requires physically disassembling the pump and associated piping or tubing and replacing the entire pump, which may be a time-consuming and expensive process, and which may be prone to producing leaks because the traditional pump must connect to and be in fluid communication with the piping or tubing comprising the fluid communication system. All of these problems associated with traditional fluid thermal control systems are eliminated by the present invention.

The invention comprises a fluid communication channel containing a ferrofluid, at least one electromagnet, at least one electromagnet electric drive circuit capable of supplying at least one time-varying electromagnet drive current to the at least one electromagnet, wherein a time-varying magnetic field is produced by the at least one electromagnet when the time-varying electric current is electrically communicated to the at least one electromagnet. The fluid communication channel containing the ferrofluid is located proximally to the at least one electromagnet such that the ferrofluid is in magnetic communication with the at least one electromagnet. The ferrofluid, which is in thermal communication with the fluid communication channel, is acted upon by the time-varying magnetic field produced by the electromagnet and is thereby motivated along the fluid communication channel. The fluid communication channel is in thermal communication with the equipment or system to be thermally managed, either directly or indirectly through a primary heat exchanger or any other thermal communication means know to a person of ordinary skill in the art, causing thermal energy to be transferred between the equipment or system and the ferrofluid. The ferrofluid is motivated by the magnetic field as described herein along the path of the fluid communication channel and is in thermal communication with a secondary system for transferring thermal energy between the ferrofluid and the secondary system, such as a secondary heat exchanger or other heat sink or source as may be known in the art. Such secondary heat exchangers may be, for example, fluid-to-air heat exchangers comprising a plurality of fins in thermal communication with the ferrofluid and also in thermal communication with free or forced air or other fluid, or may be fluid-to-fluid heat exchangers in which the ferrofluid is in thermal communication with a secondary fluid, which may itself be thermally managed to a desired temperature by any means known in the art such as, for example, known refrigeration or other cooling or heating techniques. In one embodiment of the invention in which fluid-to-air heat exchangers are utilized and in which it is desired to cool the system or equipment to be thermally managed, the thermal energy, or heat, absorbed by the ferrofluid from the system or equipment to be cooled is transferred to the secondary heat exchanger by the ferrofluid as it is motivated along the fluid communication channel to the secondary heat exchanger whereupon the thermal energy is removed from the ferrofluid to by the secondary heat exchanger and is transferred to surrounding air by free convection or forced convection of air across the fins of the fluid-to-air heat exchanger. In another embodiment of the invention in which fluid-to-fluid heat exchangers are utilized as the secondary heat exchanger, the thermal energy, or heat, absorbed by the ferrofluid from the system to be cooled is transferred to the secondary heat exchanger by the ferrofluid as it is motivated along the fluid communication channel to the secondary heat exchanger whereupon the thermal energy is removed from the ferrofluid to by the secondary heat exchanger and is transferred to a secondary fluid cooling system.

The invention may further comprise at least one fluid flow sensor that measures the flow of the ferrofluid with the fluid communication channel. The fluid flow sensor may produce an electrical fluid flow output signal that is electrically communicated to a controller adapted to receive the fluid flow output signal and also adapted to output a time-varying electromagnet drive current for driving, preferably but not necessarily through an electromagnet drive circuit, at least one electromagnet that is in magnetic communication with the ferrofluid. The time-time-varying electromagnet drive current is shaped so that the time-varying magnetic field produced by the at least one electromagnet in response to the time-varying electromagnet drive current acts upon the ferrofluid to motivate the ferrofluid within the fluid communication channel. For example, in the normal case in which it is desired to motivate the ferrofluid through the fluid communication channel of the invention, the time-varying magnetic field produced by the at least one electromagnet in response to the time-varying electromagnet drive current may be shaped so as to be in phase with the flow of the ferrofluid, thus reinforcing the motivation of the ferrofluid along the fluid communication channel. However, other uses of the time-varying magnetic field produced by the at least one electromagnet are within the scope of the invention. For example, in some situations it may be desired to retard or even stop the flow of the ferrofluid within the fluid communication channel. In this case, the time-varying magnetic field produced by the at least one electromagnet in response to the time-varying electromagnet drive current may be shaped to be out of phase with the ferrofluid so that the motivation of the ferrofluid within the fluid communication channel is retarded or even stopped. This could be desired, for instance, in cases in which it is desired to prevent over cooling of the equipment or system to be thermally managed. In this manner the invention may be controlled to maintain the equipment or system to be thermally managed at a desired temperature.

The present method and device of the invention overcome the shortcomings of the prior art by eliminating the need for unreliable and expensive traditional fluid pumps, typically comprising life-limited impellers and bearings, which are subject to a number of failure modes such as bearing failure. The present method and device eliminate or at least minimize the number of moving or rotating components in a fluid cooling system, resulting in higher reliability, longer mean times between failure, and overall reduced costs of maintenance of the cooling system.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating the preferred embodiments of the invention and are not to be construed as limiting the invention. In the drawings:

FIG. 1a depicts a block diagram view of a ferrohydrodynamic pump of the invention comprising a single electromagnet in magnetic communication with a ferrofluid contained in a fluid communication channel, in which the single electromagnet is in electrical communication with an electromagnet electric drive circuit capable of supplying a time-varying electromagnet drive current to the electromagnet, producing a time-varying magnetic field motivating the ferrofluid within the fluid communication channel.

FIG. 1b depicts a block diagram view of a ferrohydrodynamic pump of the invention comprising a plurality of electromagnets in magnetic communication with a ferrofluid contained in a fluid communication channel, in which the electromagnets are in electrical communication with an electromagnet electric drive circuit capable of supplying an independent time-varying electromagnet drive current to each electromagnet, producing a time-varying magnetic field motivating the ferrofluid within the fluid communication channel.

FIG. 1c depicts a block diagram view of a ferrohydrodynamic pump of the invention comprising a two groupings of electromagnets in magnetic communication with a ferrofluid contained in a fluid communication channel, in which the electromagnets are in electrical communication with an electromagnet electric drive circuit capable of supplying a time-varying electromagnetic drive current to the electromagnet, producing a time-varying magnetic field motivating the ferrofluid within the fluid communication channel.

FIG. 2 depicts two groupings of electromagnets comprised of four electromagnets each, in which each electromagnetic is independently driven by a time-varying electromagnetic drive current, and in which the independent time-varying electromagnetic drive currents driving the electromagnets of each grouping are in a quadrature phase relationship.

FIG. 3 depicts the phase relationship of an embodiment of the invention in which the time-varying electromagnet drive current is in phase with the flow of nanoparticles within the fluid communication channel.

FIG. 4 depicts a ferrohydrodynamic pump of the invention comprised of two electromagnet assemblies, in which each of the two electromagnet assemblies further comprise two groupings of four electromagnets each.

FIG. 5a depicts an embodiment of the ferrohydrodynamic thermal management system of the invention, in which a system or equipment to be thermally managed, such as for example an Magnetic Resonance Imaging (MRI) system is thermally managed by circulating ferrofluid within a fluid communication channel through a primary heat exchanger in thermal communication with the system or equipment to be managed, and also circulating the ferrofluid within the fluid communication channel through a secondary heat exchanger.

FIG. 5b depicts an air to air secondary heat exchanger.

FIG. 5c depicts a liquid to air secondary heat exchanger.

FIG. 6 depicts an exemplary block diagram view of the controller of the ferrohydrodynamic thermal management system.

FIG. 7a depicts an exemplary partial circuit diagram of one of many embodiments of the controller of the ferrohydrodynamic thermal management system.

FIG. 7b depicts an exemplary partial circuit diagram of one of many embodiments of the controller of the ferrohydrodynamic thermal management system.

FIG. 8 depicts a flow chart of a method of thermal management of a system or equipment using the ferrohydrodynamic thermal management system and method of the invention.

### DETAILED DESCRIPTION OF THE INVENTION

The following documentation provides a detailed description of the invention.

As used herein, “ferrofluid” means colloidal liquids comprising nanoparticles that are nanoscale ferromagnetic, or ferrimagnetc, particles suspended in a carrier fluid (usually, but not necessarily, an organic solvent or water). The nanoparticles, which may be any size but are preferably between 10 and 30 nanometers in diameter, are typically coated with a surfactant to inhibit clumping of nanoparticles together. The diameter of the nanoparticles is small enough for thermal agitation, or Brownian motion, to disperse them evenly within a carrier fluid, and for them to contribute to the overall magnetic response of the ferrofluid. The nanoparticles may be typically comprised of magnetite, hematite or some other compound containing iron. The magnetic attraction of nanoparticles is typically weak enough that the surfactant's Van der Waals force is sufficient to prevent magnetic clumping or agglomeration. Ferrofluids usually do not retain magnetization in the absence of an externally applied field and thus are often classified as “superparamagnets” rather than ferromagnets. The composition of a ferrofluid may be any known combination of materials known to be classified as a ferrofluid, but a typical ferrofluid of the invention is about 5% magnetic solids, 10% surfactant and 85% carrier fluid, by volume. The magnetic solids may be, but are not necessarily, metallic nanite particles. In an embodiment of the invention an ethylene glycol/water mixture may comprise the carrier fluid, and an iron, cobalt, nickel alloy may comprise the metallic particles. Any surfactant may be used in the ferrofluid, but typical surfactants are oleic acid, tetramethylammonium hydroxide, citric acid, and soy lecithin. “Ferrofluid” also includes within its definition any fluid containing magnetorheological fluids also known as MR fluids. MR fluid particles primarily consist of micrometer-scale particles.

As used herein, “equipment or system to be thermally managed” means any system or equipment for which thermal management is desired. Thermal management means maintaining a desired temperature or range of temperature. Heating or cooling may be required to keep system or equipment at a desired temperature. An example of the kind of equipment falling within the definition of “equipment or system to be thermally managed” is an MRI machine. MRI machines may produce large amounts of heat in the process of generating the magnetic fields required for their imaging operation. The generation of stronger magnetic fields by an MRI machine, resulting in more generated heat, may be desired in order to maximize the resolution of the images produced by the MRI machines. It is typically necessary that this generated heat be removed from the MRI machine by some form of active cooling in order to keep the components of the MRI machine with a specific range. Thus the MRI machine, or its components, or both must be thermally managed in order maintain the components of the system within the desired range.

As used herein, “thermally managed” means transferring thermal energy from or to the system or equipment to be thermally managed in order to achieve and/or maintain a desired temperature for the system or equipment to be thermally managed. Thus, the ferrohydrodynamic thermal management system may be utilized to heat or cool the system or equipment to be thermally managed in order to maintain a desired temperature or temperature range. There are numerous types of equipment falling within the definition of equipment or system to be thermally managed such as, for example, MRI machines, X-ray machines, spacecraft, computer servers and server farms, and all other manner and type of equipment requiring thermal management.

As used herein, “time-varying” means a waveform that varies in amplitude or magnitude over time, or varies in frequency over time, or both. Such waveforms may be sinusoidal or any other waveshape, and need not be periodic. Such waveforms may, but do not necessarily, comprise any combination of frequencies of any amplitude such that any waveshape of any spectral content is included with the definition of “time-varying”. “Time-varying” includes any waveform comprising any spectral composition and need not be periodic. Although any the definition of time varying includes any frequency, the frequencies of the components of the time-varying waveforms of the invention may typically range between 0 Hz to 10 KHz. A preferred time-varying waveform embodiment is a sinusoid of frequency between 500 Hz and 2.5 KHz.

As used herein, “time-varying magnetic field” means any magnetic field that varies in a time-varying fashion.

As used herein, “thermal electric generator” or “TEG” means an apparatus adapted to convert thermal energy to electric energy using, for example, the Seebeck effect in which a thermal gradient formed between two dissimilar conductors produces a voltage. TEG devices may be, but are not necessarily, comprised of highly doped semiconductors made from bismuth telluride (Bi₂Te₃), lead telluride (PbTe), calcium manganese oxide, or combinations thereof.

As used herein, “fluid communication channel” means any system of tubing, conduit, piping or any structure of any cross sectional shape that is able to communicate a fluid, preferably a liquid from one position to another. The fluid communication channel is preferably, but is not necessarily, continuous, i.e., it may be but is not necessarily a closed loop system that circulates fluid, which fluid may be a liquid. The preferred fluid communication channel of the invention may comprise tubing, conduit or piping comprising a polycarbonate material or any material that is thermally conductive, although any tubing, conduit, or piping may comprise the fluid communication channel of the invention.

As used herein, “fluid flow meter” means any device capable of measuring the mass or volume flow a ferrofluid within the fluid communication channel of the invention. Specifically, the fluid flow meter may be but is not necessarily an ultrasonic Doppler flow meter as is known to persons of ordinary skill in the art, which is capable of measuring the flow rate of nanoparticles contained within the ferrofluid as it is motivated through the fluid communication channel of the invention. The output of the fluid flow meter maybe either an analog or digital representation of the mass or volume flow of ferrofluid within the fluid communication channel.

The present invention is a ferrohydrodynamic thermal management system which, in a preferred embodiment, comprises a controller that utilizes feedback from measured ferrohydrodynamic fluid flow within the fluid communication channel of the invention to control and output a time-varying electromagnet drive current to at least one electromagnet, producing a time-varying magnetic field used to control the flow of ferrofluid flow within the fluid communication channel and which is in magnetic communication with the electromagnet.

The present invention, in a preferred embodiment and best mode, comprises at least one electromagnet, a fluid communication channel comprising a ferrofluid, a controller and at least one electromagnet drive circuit for producing a time-varying electromagnet drive current, a primary heat exchanger, and a secondary heat exchanger. The ferrohydrodynamic pump may further comprise at least one electromagnet and at least one electromagnet drive circuit in electrical communication with said at least electromagnet, said at least one electromagnet electric drive circuit capable of supplying at least one time-varying electric current to said at least one electromagnet, wherein a time-varying magnetic field is produced by said electromagnet when said time-varying electromagnet drive current is electrically communicated to said at least one electromagnet.

The invention may further comprise a fluid flow meter for measuring the flow of the ferrofluid within the fluid communication channel and producing a electrical fluid flow output signal that is input to a controller adapted to receive the fluid flow output signal and also adapted to output a time-varying electrical drive signal for driving at least one electromagnet that is in magnetic communication with the ferrofluid. The controller may be any controller known in the electrical arts and may be, for example, an electric circuit comprising analog or digital components. In a preferred embodiment of the invention, the controller comprises a microcontroller, microprocessor, or similar device or plurality of devices capable of reading computer readable instructions from a non-transitory computer readable memory and executing the computer readable instructions; a non-transitory computer readable memory capable of storing instructions in electrical communication with the programmable microcontroller, microprocessor, or similar programmable device or plurality of devices; and a set of computer readable instructions stored in the non-transitory computer readable memory for controlling and producing at least one time-varying electromagnet drive current for driving the at least one electromagnet of the invention. In the preferred embodiment of the invention comprising a plurality of electromagnets, each electromagnet is driven by a time-varying electromagnet drive current. Thus the controller may comprise a plurality of independent electromagnet control channels, each electromagnet control channel independently controlled by the microcontroller, microprocessor, or similar device or plurality of devices, as instructed by the set of computer readable instructions stored in the non-transitory computer readable memory and executed by the microcontroller, microprocessor, or similar device.

A still further preferred embodiment is defined as an embodiment in which the at least one electromagnet comprises a least one grouping of four electromagnets, each of the four electromagnets being independently controlled by at least one independent time-varying electromagnet drive current produced by the controller of the invention. Thus, in this particular exemplary embodiment, the controller outputs four independent electromagnet drive current signals that may be controlled independently to be of any waveshape desired. In a further preferred embodiment of the invention, each of the four independent time-varying electromagnet drive currents is a sinusoidal current, with the four independent time-varying electromagnet drive currents being in a quadrature phase relationship; that is, using any one of the independent time-varying electromagnet drive currents as a first independent time-varying electrical drive signal of reference phase of 0 degrees, the other three independent time-varying electrical signals may be characterized as comprising a second independent time-varying electromagnet drive current of 90 degrees phase relative to the first independent time-varying electromagnet drive current, a third independent time-varying electromagnet drive current of 180 degrees phase relative to the first independent time-varying electrical drive signal, and a fourth independent time-varying electromagnet drive current of 270 degrees phase relative to the first independent time-varying electrical drive signal.

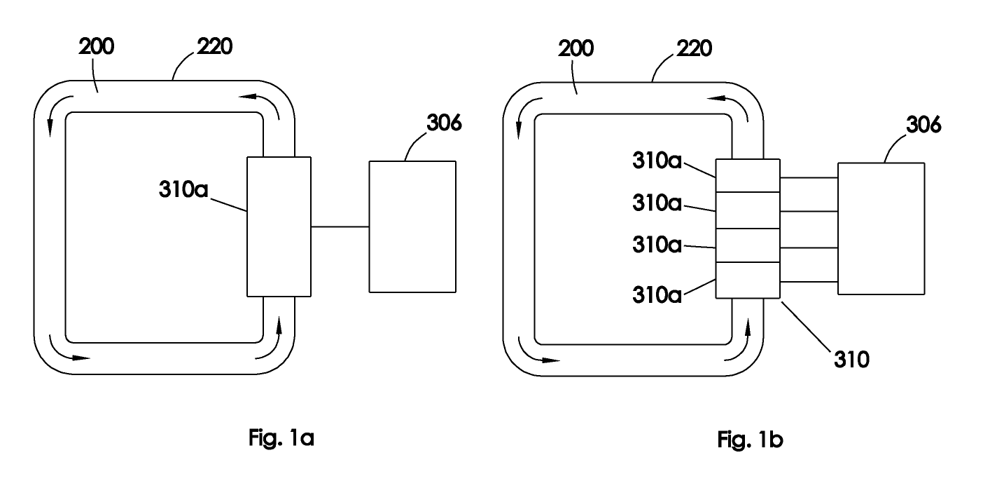

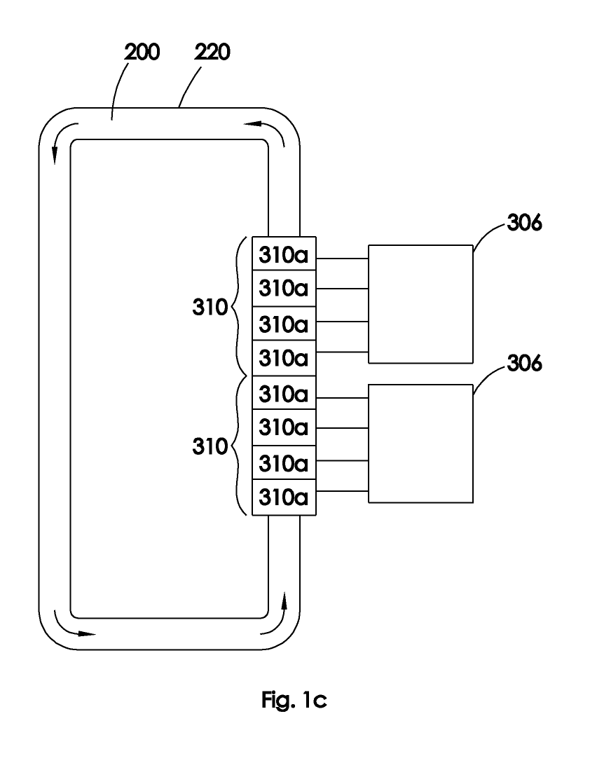

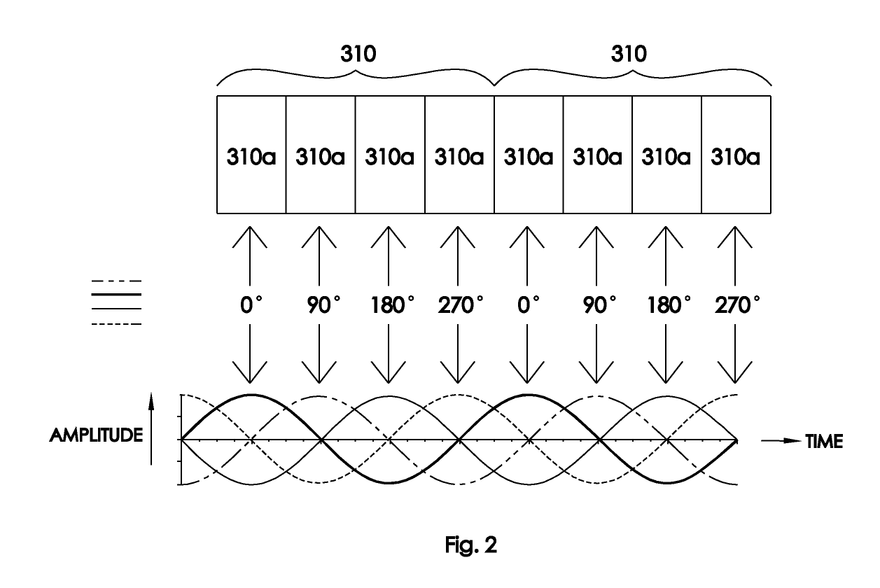

Referring now to FIG. 1a, a simplified block diagram of a ferrohydrodynamic pump of the invention is depicted. A fluid communication channel 220 contains a ferrofluid 220. An electromagnet 310a is disposed in proximity to fluid communication channel 220 such that a magnetic field generated by an electromagnet drive current passing through electromagnet 310a acts upon ferrofluid 200 contained within fluid communication channel 220. Ferrofluid 200 is in magnetic communication with electromagnet 310a. As described above, when the magnetic field generated by the electric current passing through electromagnet 310a and acts upon ferrofluid 200 contained within fluid communication channel 220, ferrofluid 200 may be motivated, for example, along the direction of the arrows as depicted in the figure. Is to be understood that the magnetic field may be a time varying magnetic field that is generated by passing a time varying electromagnet drive current from electromagnet drive circuit 306 through electromagnet 310a. As described elsewhere herein, the time-varying electromagnet drive current passing through electromagnet 310a may take any way shape desired by the user. In this manner, ferrofluid 200 contained within fluid communication channel 220 is acted upon by the time varying magnetic field generated by electromagnet 310a and is motivated to circulate as depicted in FIG. 1a.

Referring now to FIG. 1b, an exemplary alternate embodiment of a ferrohydrodynamic pump of the invention is depicted in which the ferrohydrodynamic pump comprises a grouping of a plurality of electromagnets 310a. Electromagnets 310a are disposed in proximity to fluid communication channel 220 such that a magnetic field generated by time-varying electromagnet drive currents passing through electromagnets 310a act upon ferrofluid 200 contained within fluid communication channel 220. Ferrofluid 200 is in magnetic communication with electromagnets 310a. Any number of electromagnets may comprise a grouping. In the example shown in FIG. 1b, four electromagnets 310a comprise an electromagnet grouping 310. Each of the four electromagnets is preferably independently driven by a separate time-varying electromagnet drive current from electromagnet drive circuit 306, and each of the separate electromagnet drive currents may take any wave shape of any frequency, period or spectral composition desired to achieve a desired wave shape. It is not necessary that each of the electromagnets be driven by time-varying electromagnet drive currents of similar wave shapes. In a preferred embodiment, each of the four electromagnets 310a of electromagnet grouping 310 are independently driven by sinusoidally shaped electric drive currents in a quadrature phase relationship to one another, that is to say, using a first electromagnet drive current as a reference, a second electromagnet drive current is in a phase relationship of 90° to the reference, a third electromagnetic drive current is in a phase relation of 180° to the reference, and a fourth electromagnet drive current is in a phase relationship of 270° to the reference. In this manner, each of the four electromagnets 310a of electromagnetic grouping 310 are driven independently by electromagnet drive currents of sinusoidal waveform in a quadrature phase relationship. It is to be understood that this grouping of four electromagnets independently driven by electromagnet drive currents of sinusoidal waveform in a quadrature phase relationship is an exemplary embodiment of the invention and that an electromagnetic drive current of any phase relationship or wave shape may independently drive any of the electromagnets of any electromagnet grouping.

Referring now to FIG. 1c, an exemplary embodiment of the ferrohydrodynamic pump of the invention is depicted in which the ferrohydrodynamic pump of the invention comprises two groupings 310 of four electromagnets 310a each such that each grouping comprises a first, second, third, and fourth electromagnet 310a. Electromagnet drive circuits 306 are in independent electrical communication with electromagnets 310a such that electromagnet drive circuit 306 provides independent electromagnet drive currents, preferably but not necessarily time-varying, to each electromagnet 310a of each electromagnet grouping 310. As described elsewhere herein, each of the electromagnets 310a of the two groupings of electromagnets 310 may be independently driven by time-varying electromagnet drive currents such that any electromagnetic drive current wave shape or phase relationship to any other electromagnetic drive current may comprise the invention. In a preferred embodiment, a first electromagnet 310a of a first electromagnet grouping 310 may be driven by a time-varying electromagnet drive current in phase with a first electromagnet 301a of a second electromagnet grouping 310 such that the magnetic field produced by the first electromagnet of the first electronic grouping is in phase with the magnetic field produced by the second electromagnet of the second electromagnet grouping. Using the drive current of the first electromagnets of the first and second groupings as a reference, the second electromagnet of the first electromagnet grouping and the second electromagnet of the second electromagnet grouping may be driven by a time-varying electromagnet drive current in a 90° phase relationship to the reference. The third electromagnet of the first electromagnet grouping and the third electromagnetic of the second electromagnet grouping may be driven by a time-varying electromagnet drive current in a 180° phase relationship to the reference. The fourth electromagnet of the first electromagnet grouping and the fourth electromagnet of the second electromagnet grouping may be driven by a time-varying electromagnet drive current in a 270° phase relationship to the reference. In this manner, the first, second, third and fourth electromagnets of each grouping are each in phase with one another and are in a quadrature phase relationship with the other electromagnets of the electromagnet groupings, producing a more intense magnetic field that is in magnetic communication with the ferrofluid contained within the fluid communication channel 220 and causing a higher degree of motivation of the ferrofluid over the ferrohydrodynamic pumps depicted in FIGS. 1a and 1b.

Referring now to FIG. 2, a phase relationship between four independent electromagnet drive currents independently driving the four electromagnets 310a of a first electromagnet grouping 310 and a second electromagnet grouping 310 is depicted. In this particular embodiment of the invention, the invention comprises two groupings of electromagnets comprising four electromagnets each. Time is represented on the horizontal axis of the figure and amplitude is represented on the vertical axis of the figure. The waveforms depicted in this exemplary alternate embodiment of the invention correspond to the block diagram depicted in FIG. 1c and described above. In this exemplary embodiment, the invention comprises a quadrature phase relationship between each of the four electromagnets 310a of each electromagnet grouping 310 as depicted in the figure. Each of the four independent electromagnet drive currents are sinusoidal in shape in this particular embodiment, although the invention may comprise any wave shape or amplitude as desired to drive any of the independent electromagnets of any of the groupings. Thus, in the preferred embodiment depicted in FIG. 2, a first electromagnet 310a of a first electromagnet grouping 310 may be driven by an electromagnet drive current in phase with a first electromagnet 310a of a second electron a magnet grouping 310 such that the magnetic fields produced by the first electromagnet of the first electromagnet grouping is in phase with the magnetic field produced by the second electromagnet of the second electromagnet grouping. Using the drive current of the first electromagnets of the first and second groupings as a reference, the second electromagnet of the first electromagnet grouping and the second electromagnet of the second electromagnet grouping may be driven by an electromagnet drive current in a 90° phase relationship to the reference. The third electromagnet of the first electromagnet grouping and the third electromagnetic of the second electromagnet grouping may be driven by an electromagnet drive current in a 180° phase relationship to the reference. The fourth electromagnet of the first electromagnet grouping and the fourth electromagnet of the second electromagnet grouping may be driven by an electromagnet drive current in a 270° phase relationship to the reference. In this manner, the first, second, third and fourth electromagnets of each grouping are each in phase with one another and in a quadrature phase relationship with the other electromagnets of the electromagnet groupings, producing a more intense magnetic field that is in magnetic communication with the ferrofluid contained within the fluid communication channel 220 (not depicted in FIG. 2) and causing a higher degree of motivation of the ferrofluid over the ferrohydrodynamic pumps depicted in FIGS. 1a and 1b.

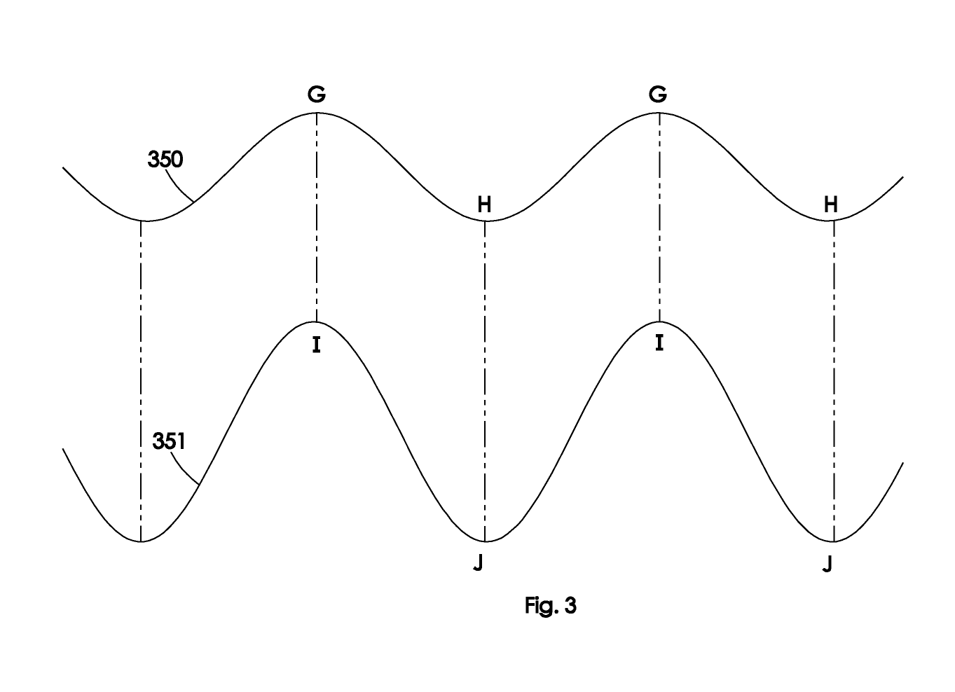

Referring now to FIG. 3, an exemplary phase relationship between a measurement of the flow of ferrofluid within the fluid communication channel and an electromagnet drive current of the invention is depicted. The fluid flow meter of the invention 320 (not shown in FIG. 3) measures the flow of ferrofluid within the fluid communication channel 220 (not shown in FIG. 3) to produce an electrical signal that is a digital or analog representation of the mass or volume flow of ferrofluid 200 within fluid communication channel 220. The resulting fluid flow waveform 350 may be as depicted in FIG. 3. In the case in which it is desired to amplify the flow rate of ferrofluid 200 (not shown in FIG. 3) within the fluid communication channel 220 (not shown in FIG. 3), the electromagnets of the invention may be driven by the time-varying electromagnet drive current 351 such a fashion as to be in phase with the measured fluid flow 350. It can be seen in the figure that measured fluid flow 350 is in phase with electromagnet drive current 351; that is the peaks G and valleys H of the measured fluid flow 350 are in phase with the peaks I and valleys J respectively of electromagnet drive current 351. In this manner, the flow of ferrofluid 200 within the fluid communication channel 220 may be maximized. It can be seen from the figure that controller 300 (not shown in FIG. 3) may be utilized to produce any waveform desired. Thus, the phase relationship of electromagnet drive current 351 to measured fluid flow rate 350 maybe any phase relationship desired. For instance, if it is desired to retard the flow of ferrofluid 200 within fluid communication channel 220, the phase relationship between the time-varying electromagnet drive current 351 and the measured fluid flow rate 350 may be a 180°, or out of phase, relationship (not depicted in FIG. 3). Likewise, any phase relationship between electromagnet drive current 351 and measured fluid flow rate 350 desired in order to achieve a desired measured fluid flow rate 350 may be achieved by the invention, resulting in any effect desired including advancing the flow of ferrofluid 200 within fluid communication channel 220, retarding the flow of ferrofluid 200 within fluid communication channel 220, or any other desired effect on the flow rate of ferrofluid 200 within fluid communication channel 220. The flow rate of ferrofluid 200 within fluid communication channel 220 may therefore be commanded by controller 300 in response to, for example, user input or temperature data collected from thermal probes placed along the fluid communication channel, on the heat exchangers that are in thermal communication with the fluid communication channel, or any other component of the ferrohydrodynamic thermal management system of the invention or the equipment to be thermally managed. Such thermal probes may be in thermal communication with any of these components by physical contact or may be, for example, thermal probes that are in optical communication with the system or equipment to be thermally managed or the thermal management system of the invention such as, for example, infrared sensors, infrared imagers or infrared cameras. In this manner, the ferrohydrodynamic thermal management system of the invention may utilize temperature input data to control the electromagnetic drive current to a desired phase relationship with the measured ferrofluid flow as measured by fluid flow meter 320, resulting in a change in the measured ferrofluid flow rate 350 in order to achieve a desired temperature.

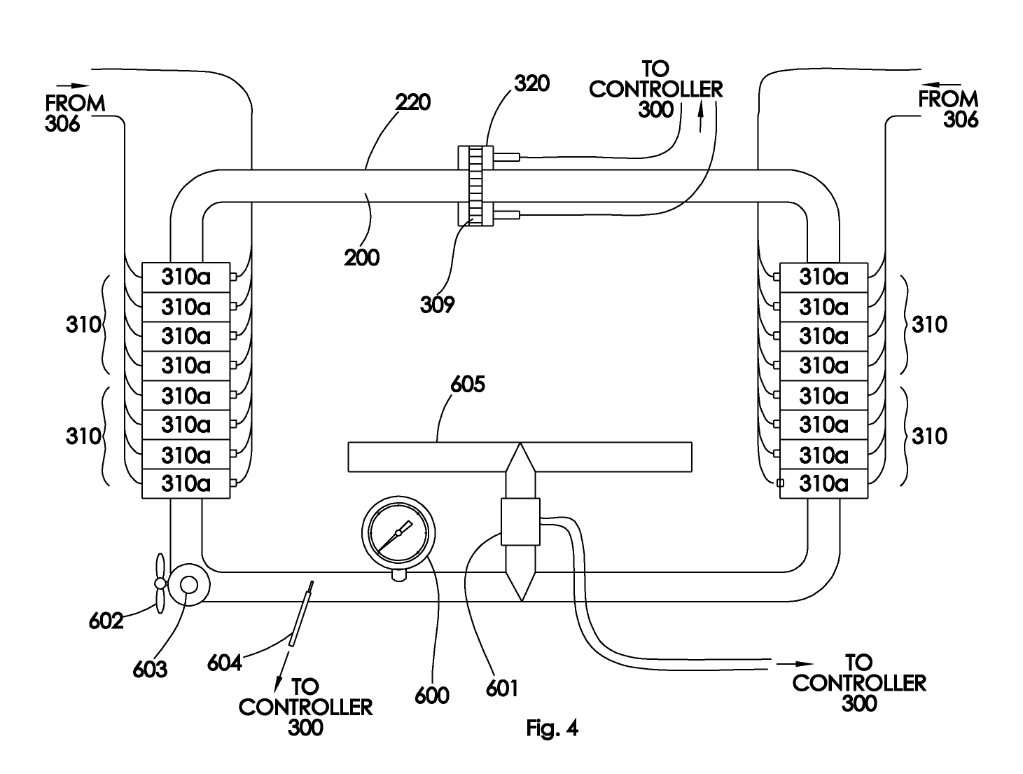

Referring now to FIG. 4, an exemplary embodiment of the ferrohydrodynamic pump of the system is depicted in which four groupings 310 of four electromagnets 310a comprise the invention, resulting in a total sixteen of electromagnets 310a, each independently driven by a time-varying electromagnet drive current communicated from electromagnet drive circuit 306 (not shown in FIG. 4). Fluid communication channel 220 contains ferrofluid 200, which is in magnetic communication with each of the electromagnets 310a. The pump may further comprise pressure gauge 600 and fill port 603, controlled by valve 602, for filling fluid communication channel 220 with ferrofluid 200, or draining ferrofluid 200 from fluid communication channel 220. Fluid flow meter 320 may measure the flow rate of nanoparticles within ferrofluid 200 as it is motivated within fluid communication channel 220, and provides an analog or digital electrical signal that is a representation of the flow rate of nanoparticles within ferrofluid 200 to controller 300 (not shown in FIG. 4). Temperature probe 604 may provide an electrical signal that is a representation of the temperature of fluid communication channel 220, ferrofluid 200, or both, and may provide this electrical signal to controller 300. Overpressure valve 601 is in electrical communication with controller 300 and is controlled by controller 300 such that when pressure within fluid communication channel 220 exceeds a threshold value, the valve will open, allowing pressurized ferrofluid 200 to escape into expansion chamber 605 such that and overpressure condition does not exist in fluid communication channel 220.

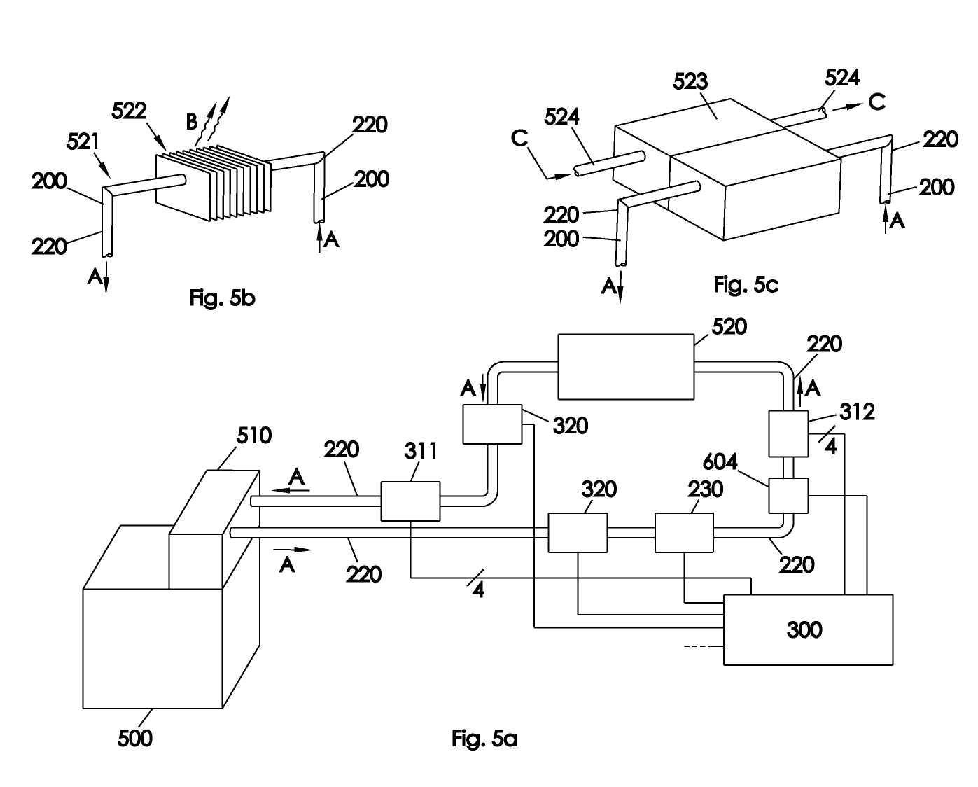

Referring now to FIGS. 5a, 5b and 5c, an exemplary embodiment of the ferrohydrodynamic thermal management system of the invention is depicted in block diagram form. A system or equipment that is to be thermally managed 500, which may be for instance an MRI machine or any machine or system that is desired to be thermally managed, is in thermal communication with a primary heat exchanger 510. In the case in which the system or equipment to be thermally managed 500 is an MRI machine, primary heat exchanger 510 may be a heat exchanger in thermal communication with a cryogenic cooling system that is utilized to cool the MRI machine. Fluid communication channel 220 and ferrofluid 200 of the invention are in thermal communication with primary heat exchanger 510. In the case in which it is desired to cool the system or equipment to be thermally managed 500, ferrofluid 200 is motivated through fluid communication channel 220 to absorb thermal energy from primary heat exchanger 510, causing the temperature of ferrofluid 200 within fluid communication channel 220 to rise. Electromagnet assemblies 311 and 312 may comprise one or more groupings of electromagnets. In a preferred embodiment, electromagnet assembly 311 comprises two groupings of four electoral magnets each, and electromagnet assembly 312 likewise comprises two groupings of four electromagnets each. Each of the electromagnets may be independently driven by time-varying electromagnet drive currents produced by electromagnet drive circuit 306 (not shown in FIG. 5a, 5b or 5c). Each of the electromagnets comprising electromagnet assembly 311 and electromagnets comprising electromagnet assembly 312 may be independently driven in the manner described herein; that is to say, each electromagnet may be independently driven by a time-varying electromagnet drive current which may be any way shape desired but may be, for example, driven by time-varying electromagnet drive current this is sinusoidal and in phase with the measured flow rate of ferrofluid 200 within fluid communication channel 220 as measured by fluid flow meters 320. In the particular exemplary embodiment depicted in FIG. 5a, two fluid flow meters 320 are shown, but the invention may comprise any number of fluid flow meters 320. In the embodiment depicted in FIG. 5a, one or more groupings of electromagnets may comprise the invention, and each grouping of electromagnets may comprise any number electromagnets. For exemplary purposes only, two groupings of four electromagnets each are shown and described, but any number of groupings of electromagnets may comprise the invention.

Still referring to FIGS. 5a, 5b and 5c, ferrofluid 200 is motivated within fluid communication channel 220 and passes through secondary heat exchanger 520. Fluid communication channel 220 and ferrofluid 200 of the invention are in thermal communication with secondary heat exchanger 520. In the case in which it is desired to cool the system or equipment to be thermally managed 500, thermal energy is transferred from ferrofluid 200 within fluid communication channel 220 to the secondary heat exchanger 520 where it may be further transferred to an external heat sink, not shown in the diagram. For instance, secondary heat exchanger 520 may comprise a liquid to air heat exchanger utilizing a plurality of heat fins 522 as shown in FIG. 5b. It can be seen that in this manner ferrofluid 200 will transfer thermal energy to the surrounding air through radiation B which may be aided by free convention or forced air passing over the plurality of heat fins 522. Alternatively, secondary heat exchanger 520 may comprise a liquid to liquid heat exchanger 523 as depicted in FIG. 5c, in which thermal energy is transferred from ferrofluid 200 contained within fluid communication channel 200 to an external heat sink which may be, for example, a liquid coolant system comprising another fluid communication channel 524 circulating a fluid in the direction C which may be, for instance any liquid cooling system known in the art such as a chiller. In this manner, thermal energy is transferred from the system or equipment to be thermally managed 500 to an external heat sink, causing equipment 500 to be cooled.

Still referring to FIGS. 5a, 5b and 5c, it is to be understood that the system or equipment to be thermally managed 500 may also be heated by the transfer of thermal energy into equipment 500 from ferrofluid 200 circulating within fluid communication channel 220 in a reciprocal heat transfer process in which thermal energy is transferred from an external heat source through secondary heat exchanger 520 to ferrofluid 200, and wherein ferrofluid 200 is circulated within fluid communication channel 220 passing through primary heat exchanger 510 and transferring thermal energy thereby into the system or equipment to be managed 500. Thus the thermal management system of the invention may be used to transfer heat from or to a system to be thermally managed 500 as desired by the user; in other words, the thermal energy transfer of the ferrohydrodynamic thermal management system of the invention may be bi-directional.

Still referring to FIGS. 5a, 5b, and 5c, an exemplary direction of ferrofluid 200 flow A is depicted, but ferrofluid 200 may flow in any direction.

Still referring to FIGS. 5a, 5b, and 5c, the invention may comprise at least one thermal electric generator 230 in thermal communication with fluid communication channel 220 and ferrofluid 200. Thermal electric generator 230 may operate to generate electric current from the thermal energy of ferrofluid 200 as ferrofluid 200 is heated as described herein. Thermal electric generator 230 is in electrical communication with and provides power to controller 300, or may provide power to any element of the invention or to any element external to the invention. For example, the electrical current output of thermal electric generator 230 may be used to charge backup batteries for operating the invention through a failure of an external source of power, thereby continuing to thermally manage the system or equipment to be managed 500 during a power failure, especially power failures of short duration.

The invention may further comprise at least one temperature probe 604 in thermal communication with fluid communication channel 220 and ferrofluid 200 and in electrical communication with controller 300. The electrical signal produced by temperature probe 604 may be read by controller 300, whereupon controller 300 may execute instructions stored in non-transitory computer readable memory 302 (not shown in FIG. 5a, 5b or 5c) to produce time-varying electromagnet drive currents to advance the flow of ferrofluid 200 in fluid communication channel 220 in the cases in which more thermal transfer is desired, or to retard the flow of ferrofluid 200 in fluid communication channel 220 in the cases in which less thermal transfer is desired, depending upon whether the measured temperature as determined by temperature probe 604 is higher or lower than a threshold temperature value or range of values.

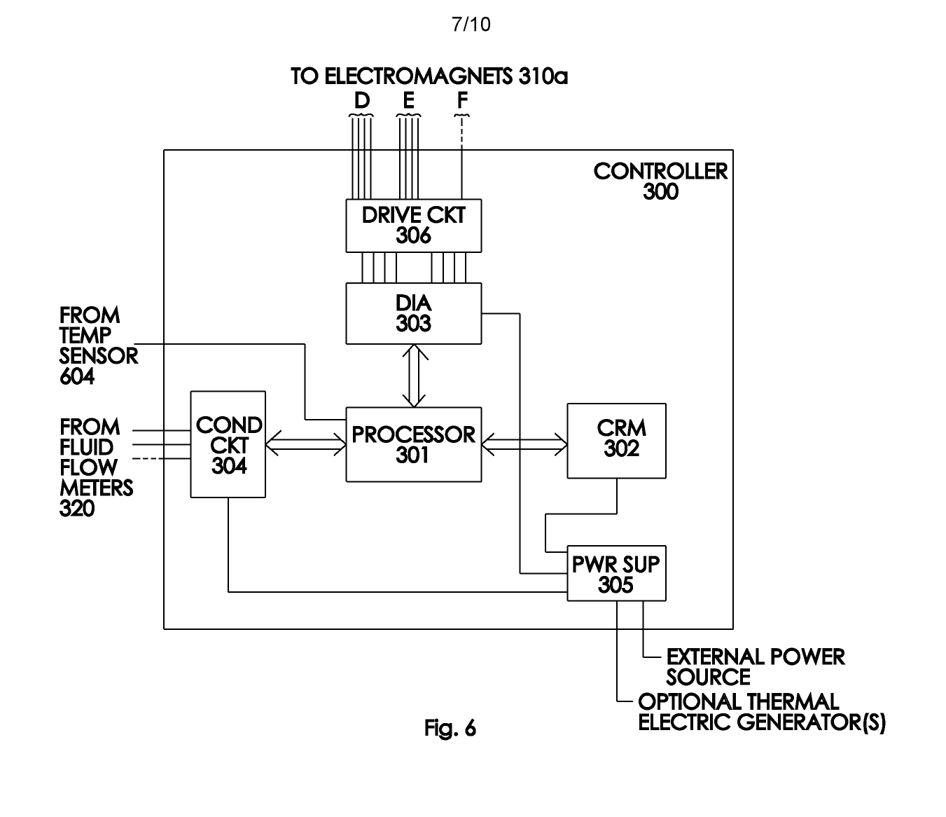

Referring now to FIG. 6, a block diagram of the controller 300 of the invention is depicted. A processor 301, which may be any microprocessor, microcontroller, firmware controller or any other processor or controller capable of reading and executing computer readable instructions from any computer readable medium, such as any non-transitory or other memory known in the art, is in electrical communication with a non-transitory computer readable memory (CRM) 302, and is also in electrical communication with fluid flow meter input conditioning circuit 304 and digital to analog converter (D/A) 303. Non-transitory computer readable memory 302 may comprise computer readable instructions stored thereon to be read by processor 301 for carrying out the functions and methods of the invention. It is to be understood that computer readable memory 302 is non-transitory and may be physically located within processor 301 or may be located separate from but in electrical communication with processor 301. Processor 301 subsequently executes said computer readable instructions to carry out the steps of the method of the invention, and to cause the invention operate as herein described. It is within the scope of the invention that processor 301 and non-transitory computer readable memory 302 may be any processor and non-transitory computer readable memory known to one of ordinary skill in the art. Processor 301 may also be in electrical communication with power supply 305 which operates to convert the external power provided by an external power source into electrical power of the appropriate voltage and current capacity to power the electrical components of controller 300. The external power source may be any power source known in the art such as standard alternating current house supply, direct-current supplies, battery backup supply provide backup power when primary power sources fail, or any other external power source known in the art.

Still referring to FIG. 6, analog to digital converter 303 is in electrical communication with electromagnet drive circuit 306, which provides the time varying electromagnetic drive signal 351 to the electromagnets of the invention.

Still referring to FIG. 6, basic operation of a controller of the ferrohydrodynamic thermal system of the invention is now described. Fluid flow meter conditioning circuit 304 may receive electrical signals from one or more fluid flow meters 320 (not shown in FIG. 6) that may be placed in one or more locations along the fluid communication channel 220 in proximity to ferrofluid 200 such that fluid flow meters 320 are able to measure the flow of nanoparticles contained within the ferrofluid as the ferrofluid is motivated through fluid communication channel 220. The electrical signal(s) produced by fluid flow meter(s) 320 may be analog or digital signals, but are typically analog signals, that are directly proportional to the rate of flow of nanoparticles in the ferrofluid. In the case in which the electrical signals from fluid flow meters 320 are analog signals, fluid flow meter input conditioning circuit 304 operates to receive the electrical signals from fluid flow meters 320 and to convert them to digital format such that the resulting digital signal is a digital representation of the analog electrical signals is received from fluid flow meters 320. In the case in which electrical signals from fluid flow meters 320 are digital signals, fluid flow meter input conditioning circuit 304 operates to receive the electrical signals from fluid flow meters 320 and, if necessary, convert them to digital signals that are a digital representation of the electrical output of fluid flow meters 320. In either case, the output of conditioning circuit 304 is a digital representation of the flow of nanoparticles in the ferrofluid contained within fluid communication channel 220.

Still referring to FIG. 6, processor 301, executing computer readable instructions as read from non-transitory computer readable memory 302, receives the digital representation of the flow of nanoparticles in the ferrofluid from fluid flow meter input conditioning circuit 304 and produces a digital representation of a waveform of desired wave shape, which may be, for example but is not necessarily, a sinusoidal waveform between 1 and 5 KHz, and provides this digital signal representation to digital to analog converter 303. Digital to analog converter 303 converts the digital representation of the desired wave shape to an analog signal representing the desired wave shape using techniques known to a person of ordinary skill in the electrical arts to convert a digital waveform to a corresponding analog waveform. The analog signal representing the desired way shape is electrically communicated to electromagnetic drive circuit 306 which may comprise field effect transistors or other transistors sufficient to provide a desired electrical drive current to the electromagnets of the invention such that the electrical drive current comprises a wave shape that is a replication of the analog signal produced by digital to analog converter 303. In this manner, processor 301 produces a digital representation of a desired wave shape which is converted to an analog signal by digital to analog converter 303 which is electrically communicated to electromagnetic drive circuit 306 which provides the drive current capacity to drive the electromagnets 310a of the ferrohydrodynamic thermal management system of the invention. The output of electromagnetic drive circuit 306 is an electromagnet drive current that may be, but is not necessarily, time-varying such as for example the electromagnet drive current 351 that is depicted in FIG. 3. The desired wave shape produced by processor 301 may be any wave shape containing any′ number and frequency of spectral components. In a preferred embodiment, the wave shape is sinusoidal. It is to be understood that it is within the scope of the invention that any number of electromagnets may be utilized in the ferrohydrodynamic thermal management system of the invention. Thus, in the exemplary embodiment depicted in FIG. 6, a first grouping D of four electromagnet drive outputs may be utilized to drive a first grouping of four electromagnets of the system, a second grouping of four electromagnetic drive outputs E may be utilized to drive a second grouping of four electromagnets of the system, and any number of additional electromagnet drive outputs F may be utilized to drive any number of additional electromagnets. The ferrohydrodynamic thermal management system of the invention may comprise any number of electromagnets and any number of groupings of electromagnets, in which any number of electromagnets may comprise any particular grouping. It is not necessary that each grouping of electromagnets comprise the same number of electromagnets in any particular embodiment of the invention.

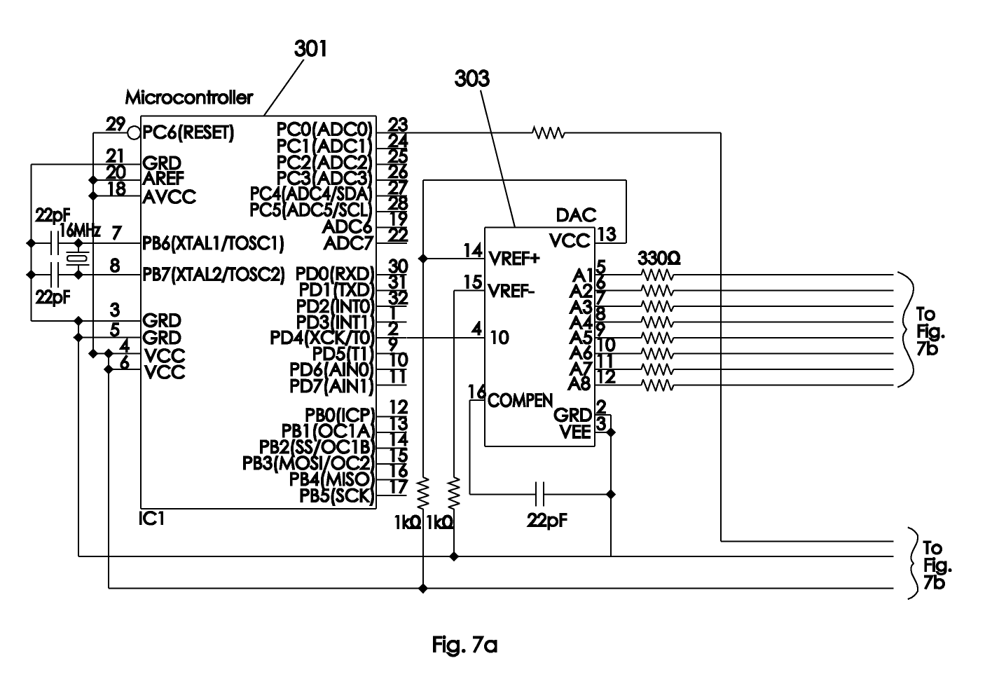

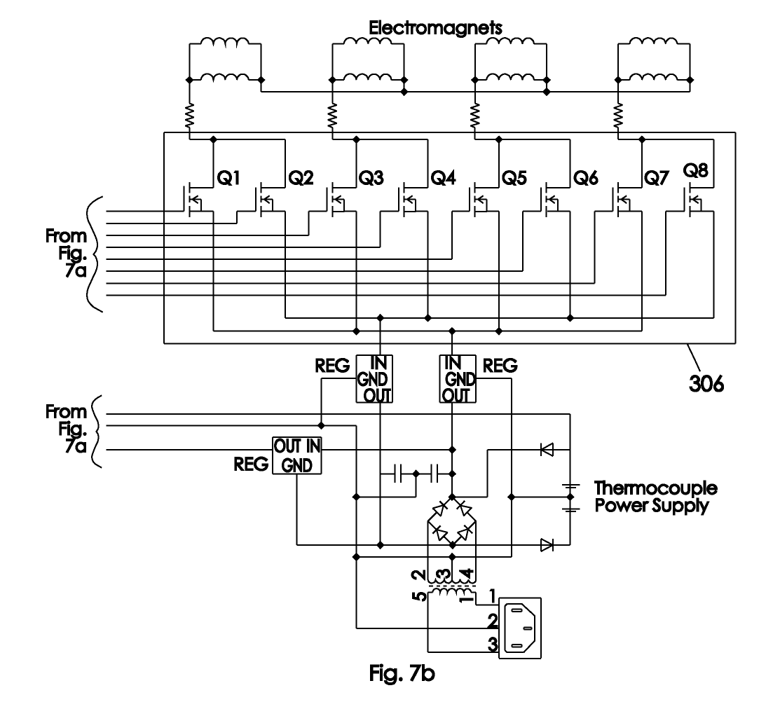

Referring now to FIGS. 7a and 7b, one of many embodiments of the controller 300 ferrohydrodynamic thermal management system of the invention is depicted in schematic form. In the particular exemplary embodiment depicted in FIGS. 7a and 7b, processor 301 is a microcontroller able to read computer readable instructions stored in non-transitory computer readable memory 302, which may be but is not necessarily on-board memory contained within processor 301. Processor 301 is in electrical communication with digital to analog converter 303 which provides the desired electromagnet drive current wave shape to power transistors Q1 through Q8 as depicted in FIG. 7b. Electromagnets 310a are disposed proximally to and in magnetic communication with the ferrofluid contained within the fluid communication channel (not depicted in FIGS. 7a and 7b) such that the electromagnetic drive current supplied by transistors Q1 through Q8 to electromagnets 310a generates a magnetic field that operates to influence and motivate the nanoparticles contained within the ferrofluid. In this manner, the ferrofluid may be motivated in any manner desired by digitally defining a desired wave shape utilizing the instructions stored in non-transitory computer readable memory 302, executing the instructions stored in non-transitory computer readable memory 300 to produce a digital representation of the desired wave shape, converting the digital representation of the desired wave shape to an analog representation of the desired wave shape, electrically communicating the analog representation of the desired wave shape to the electromagnetic drive circuit 306, driving the electromagnets 301a with time-varying electromagnet drive current of the desired wave shape and causing a time-varying magnetic field of the desired wave shape to be generated when the time-varying electromagnet drive current passes through electromagnets 301a.

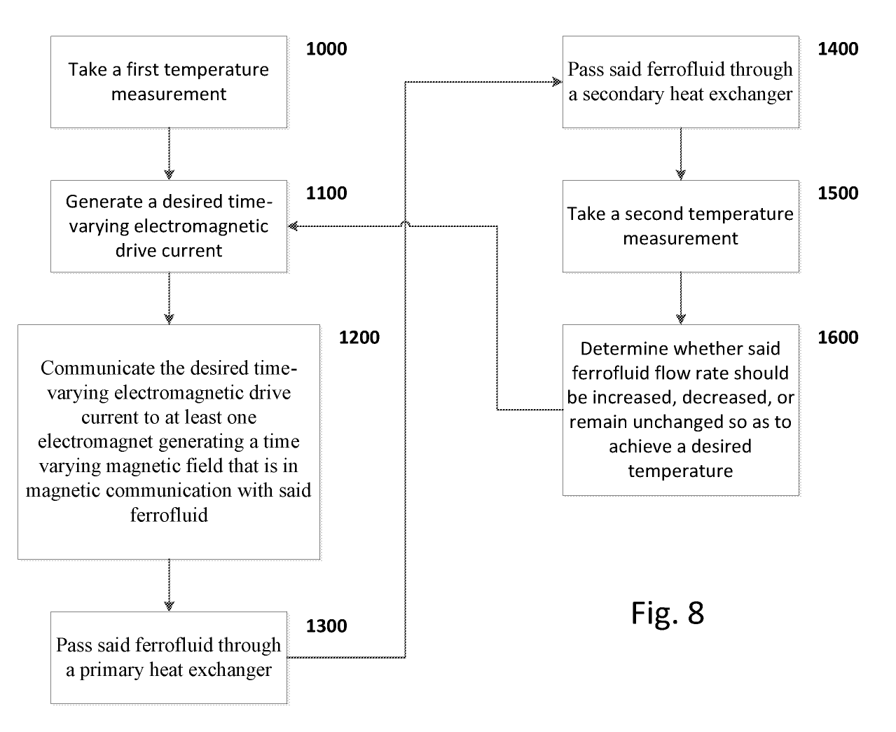

Referring now to FIG. 8 the steps of an exemplary method of the invention is depicted as comprising the steps of providing a fluid communication channel in thermal communication with a primary heat exchanger and a secondary heat exchanger, said fluid communication channel containing a ferrofluid flowing in said fluid communication channel and in thermal communication therewith; providing at least one electromagnet in magnetic communication with said ferrofluid and in electrical communication with an electromagnet drive circuit; measuring the fluid flow of ferrofluid in the fluid communication channel; taking a first measurement of the temperature of said fluid communication channel, ferrofluid, or system or equipment to be thermally managed 1000; generating a desired time-varying electromagnetic drive current in said electromagnet drive circuit to either maintain, advance or retard the flow of said ferrofluid within said fluid communication channel 1100; communicating the desired time-varying electromagnetic drive current to at least one electromagnet generating a time varying magnetic field that is in magnetic communication with said ferrofluid contained in a fluid communication channel, causing said ferrofluid to be motivated within said fluid communication channel 1200; passing said ferrofluid through a primary heat exchanger such that thermal energy is transferred from said primary heat exchanger to said ferrofluid 1300; passing said ferrofluid through a secondary heat exchanger such that thermal energy is transferred from said ferrofluid to the secondary exchanger hereby cooling the ferrofluid 1400; taking a second measurement of the temperature of said fluid communication channel, ferrofluid, or system or equipment to be thermally managed 1500; and generating a desired time-varying electromagnetic drive current in said electromagnet drive circuit to either maintain, advance or retard the flow of said ferrofluid within said fluid communication channel to achieve a desired temperature of said fluid communication channel, ferrofluid, or system or equipment to be thermally managed 1600.

In a further embodiment of the method of the invention, the ferrohydrodynamic pump may be free running; that is, may operate without temperature or ferrofluid flow rate information and may comprise a default time-varying waveform

In a further alternate embodiment of the method of the invention, the at least one electromagnet may be further defined as at least one grouping of a plurality of electromagnets independently driven by independent time-varying electromagnet drive currents. In a further embodiment, the plurality of electromagnets is defined as four electromagnets, and the independent time-varying electromagnet drive currents are defined as sinusoidal electric currents in a quadrature phase relationship.

In an alternate embodiment of the method of the invention, the time-varying electromagnet drive current is sinusoidal and is in phase with the measured flow of ferrofluid.

In a still further alternate embodiment of the method of the invention, the frequency of the sinusoidal time-varying electromagnet drive current is between 500 Hz and 2.5 KHz.

The invention may further comprise a startup sequence, or series of steps, which method comprises applying power to the controller, and in which the processor reads and executes a startup of instructions from the non-transitory computer readable memory comprising the steps of measuring the fluid flow of ferrofluid in a fluid communication channel of a ferrohydrodynamic thermal management system of the invention; generating at least one sinusoidal electromagnet drive current which may be any frequency but is preferably between 500 Hz and 2.5 KHz, communicating the sinusoidal electromagnet drive current which may be any frequency but is preferably between 500 Hz and 2.5 KHz to at least one electromagnet; measuring the resulting ferrofluid flow rate; and repeating the measurement of resulting ferrofluid flow rate until a desired measured fluid flow rate is achieved.

Only those claims utilizing the term “means for” are intended to be interpreted under 35 U.S.C. 112, sixth paragraph. No other claims or terms are to be construed as falling under this paragraph.

Although a detailed description as provided in the attachments contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention. Thus the scope of the invention should be determined by the appended claims and their legal equivalents, and not merely by the preferred examples or embodiments given.

What is claimed is:

1. A ferrohydrodynamic thermal management system, comprising:
at least one electromagnet;
at least one electromagnet drive circuit in electrical communication with said at least electromagnet, said at least one electromagnet electric drive circuit capable of supplying at least one time-varying electromagnet drive current to said at least one electromagnet, wherein a time-varying magnetic field is produced by said electromagnet when said time-varying electromagnet drive current is electrically communicated to said at least one electromagnet;
a fluid communication channel containing a ferrofluid wherein said ferrofluid is in magnetic communication with said at least one electromagnet and is acted upon by said time-varying magnetic field such said ferrofluid is motivated within said fluid communication channel; and
a primary heat exchanger in thermal communication with said ferrofluid and a secondary heat exchanger in thermal communication with said ferrofluid.

2. The ferrohydrodynamic thermal management system of claim 1, wherein said at least one electromagnet is further defined as a plurality of electromagnets, and wherein said at least one time-varying electromagnet drive current is further defined as a plurality of independent time-varying electromagnet drive currents, each one of said plurality of independent time-varying electromagnet drive currents being independently electrically communicated to one of said plurality of electromagnets such that a time varying magnetic field is independently produced from each of said plurality of electromagnets when said time-varying electromagnet drive currents are communicated to said electromagnets.

3. The ferrohydrodynamic thermal management system of claim 1, wherein said at least one time-varying electromagnet drive current is sinusoidal.

4. The ferrohydrodynamic thermal management system of claim 2, wherein each of said plurality of time-varying electromagnet drive currents is sinusoidal.

5. The ferrohydrodynamic thermal management system of claim 1, further comprising a controller capable of executing computer readable instructions, and a fluid flow meter producing an electric signal representing the flow of said ferrofluid within said fluid communication channel, wherein said controller is in electrical communication with said electromagnetic drive circuit and with said fluid flow meter, and wherein said controller is in electrical communication with a non-transitory computer readable memory containing instructions for generating said at least one time-varying electromagnet drive current.

6. The ferrohydrodynamic thermal management system of claim 5, wherein said at least one time-varying electromagnet drive current is sinusoidal.

7. The ferrohydrodynamic thermal management system of claim 6, wherein said at least one sinusoidal time-varying electromagnet drive current is in phase with said fluid flow meter electric signal.

8. The ferrohydrodynamic thermal management system of claim 5, further comprising a thermal electric generator in thermal communication with said fluid communication channel, and wherein said thermal electric generator is in electrical communication with and providing electric power to said controller.

9. The ferrohydrodynamic thermal management system of claim 2, wherein said plurality of electromagnets is further defined as a plurality of groupings of electromagnets, each grouping comprising a first electromagnet, a second electromagnet, a third electromagnet, and a fourth electromagnet, and wherein said plurality of time-varying electric currents is further defined as a plurality of groupings of time-varying electric currents, each grouping comprising a first time-varying electromagnet drive current electrically communicated to said first electromagnet, a second time-varying electromagnet drive current electrically communicated to said second electromagnet, a third time-varying electromagnet drive current electrically communicated to said third electromagnet, and a fourth time-varying electromagnet drive current electrically communicated to said fourth electromagnet.

10. The ferrohydrodynamic thermal management system of claim 9, wherein each of said first, second, third and fourth time-varying electromagnet drive currents are sinusoidal.

11. The ferrohydrodynamic thermal management system of claim 9, wherein each of said first, second, third and fourth time-varying electromagnet drive currents are in a quadrature phase relationship.

12. A method for thermally managing a system or equipment, comprising the steps of:
providing a fluid communication channel in thermal communication with a primary heat exchanger and a secondary heat exchanger, said fluid communication channel containing a ferrofluid flowing in said fluid communication channel;
providing at least one electromagnet in magnetic communication with said ferrofluid and in electrical communication with an electromagnet drive circuit;
measuring the fluid flow of ferrofluid in said fluid communication channel;
taking a first measurement of the temperature of said fluid communication channel, ferrofluid, or system or equipment to be thermally managed;
generating a desired time-varying electromagnetic drive current in said electromagnet drive circuit to either maintain, advance or retard the flow of said ferrofluid within said fluid communication channel;
communicating the desired time-varying electromagnetic drive current to at least one electromagnet generating a time varying magnetic field that is in magnetic communication with said ferrofluid contained in a fluid communication channel, causing said ferrofluid to be motivated within said fluid communication channel;
passing said ferrofluid through a primary heat exchanger such that thermal energy is transferred from said primary heat exchanger to said ferrofluid;
passing said ferrofluid through a secondary heat exchanger such that thermal energy is transferred from said ferrofluid to the secondary exchanger hereby cooling the ferrofluid;
taking a second measurement of the temperature of said fluid communication channel, ferrofluid, or system or equipment to be thermally managed; and
generating a desired time-varying electromagnetic drive current in said electromagnet drive circuit to either maintain, advance or retard the flow of said ferrofluid within said fluid communication channel to achieve a desired temperature of said fluid communication channel, ferrofluid, or system or equipment to be thermally managed.

13. The method of claim 6, wherein said at least one electromagnet is a plurality of electromagnets.

14. The method of claim 7, wherein said plurality of electromagnets is further defined as a plurality of groupings of electromagnets, wherein each grouping comprises four electromagnets.

15. The method of claim 6, wherein said time varying electromagnet drive current is sinusoidal.

16. The method of claim 7, wherein said time varying electromagnet drive current is sinusoidal.

17. The method of claim 8, wherein said time varying electromagnet drive current is sinusoidal.

18. The method of claim 9, wherein said time varying electromagnet drive current is in phase with said measured ferrofluid flow.

19. The method of claim 10, wherein said time varying electromagnet drive current is in phase with said measured ferrofluid flow.

20. The method of claim 11, wherein said time varying electromagnet drive current is in phase with said measured ferrofluid flow.
